(19) United States
(12) Patent Application Publication
(10) Pub. No.: US 2018/0365634 A1
(43) Pub. Date: Dec. 20, 2018

(54) SYSTEM AND METHOD FOR FACILITATING MODEL-BASED TRACKING-RELATED PREDICTION FOR SHIPPED ITEMS

(71) Applicant: Stamps.com Inc., El Segundo, CA (US)

(72) Inventors: John CLEM, Manhattan Beach, CA (US); Charles ATKINSON, El Segundo, CA (US); Fabian KWAK, Pasadena, CA (US)

(21) Appl. No.: 15/628,323

(22) Filed: Jun. 20, 2017

(51) Int. Cl. G06Q 10/08; G06N 5/02; G06N 99/00

(52) U.S. Cl. CPC G06Q 10/0833; G06N 99/005; G06N 5/025

(57) ABSTRACT

In certain embodiments, model-based tracking-related prediction for shipped containers may be provided. In some embodiments, scan event information may be obtained. The scan event information may indicate a first-location scan event associated with a first container that occurred at a first location, a first-location scan event associated with a second container that occurred at the first location, and a second-location scan event associated with the first container that occurred at a second location. A prediction model may be used, without a second-location scan event for the second container occurring at the second location, to generate a prediction regarding (i) the second container being at the second location subsequent to being at the first location and (ii) the second container being at a third location subsequent to being at the second location. The prediction may be generated, using the prediction model, based on the scan event information.

### FIELD OF THE INVENTION

The invention relates to tracking-related predictions for shipped containers, including, for example, the use of a neural network or other prediction model to generate tracking-related predictions regarding shipped containers or other items.

### BACKGROUND OF THE INVENTION

Traditional postal tracking computer systems enable their users (e.g., shippers of packages, recipients of packages, or other users) to access and view tracking information regarding their packages. Oftentimes, however, during a distribution center's processing of thousands of packages (as well as containers that each contain tracked packages) per day, the tracking barcodes (representing the tracking identifiers) of many such packages or other containers fail to be scanned, and, thus, no scan event indicating that those packages/containers arrived or departed the distribution center may be available, preventing the traditional postal tracking computer systems from providing their users with tracking information for those packages/containers with respect to that distribution center. These and other drawbacks exist.

### SUMMARY OF THE INVENTION

Aspects of the invention relate to methods, apparatuses, and/or systems for facilitating model-based tracking-related prediction for shipped containers.

In some embodiments, a neural network or other prediction model may be used to generate a prediction regarding a container (or other item) being at a particular location, a prediction regarding the container being at a different location subsequent to the particular location, or other prediction. In some embodiments, when the prediction is generated, no scan event for the container has occurred at the location or some other issue prevented scan event information for the container for the location from being obtained. Additionally, or alternatively, no user input (or other input) identifying that the container was actually at the location at the time of the prediction. In some embodiments, the prediction model may be trained and utilized for predicting (i) which processing/distribution centers (or other locations) a container (or other item) has been or will be routed, (ii) particular times at which the container is or will be located at respective locations, (iii) the total delivery time for the container or time of arrival of the container at its final destination, (iv) probabilities regarding the foregoing predictions, or (v) other information. The prediction model may, for example, be self-learning and trained, rather than explicitly programmed, and can perform significantly better in certain areas of problem solving, as compared to traditional computer programs.

In some embodiments, information regarding 500 or more scan events, 1000 or more scan events, 10000 or more scan events, 100000 or more scan events, 1000000 or more scan events, or other number of scan events may be provided as input to the prediction model (e.g., as parameters or other type of input) to train the prediction model to predict shipping-related events. Each of the scan events may correspond to a scan of a container at a processing/distribution center or other location. Additionally, or alternatively, information indicating, for each container for which at least one of the scan events (e.g., the 500-1000000 or more scan events) has occurred at a processing/distribution center or other location, (i) a destination associated with the container, (ii) a shipping service type associated with the container, (iii) an originating point associated with the container, or (iv) other information may be provided as input to the prediction model (e.g., as parameters or other type of input) to train the prediction model to predict shipping-related events.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for facilitating tracking-related prediction for shipped containers, in accordance with one or more embodiments.

FIG. 2A shows a diagram depicting nodes representing locations at which a shipped container can be processed, edges representing relationships between the locations, and containers to be routed through one or more of the locations, in accordance with one or more embodiments.

FIG. 2B shows containers that each contains one or more tracked containers, in accordance with one or more embodiments.

FIG. 3 shows a flowchart of a method of facilitating model-based tracking-related prediction for shipped containers, in accordance with one or more embodiments.

FIG. 4 shows a flowchart of a method of facilitating neural-network-based tracking-related prediction for shipped containers, in accordance with one or more embodiments.

### DETAILED DESCRIPTION OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

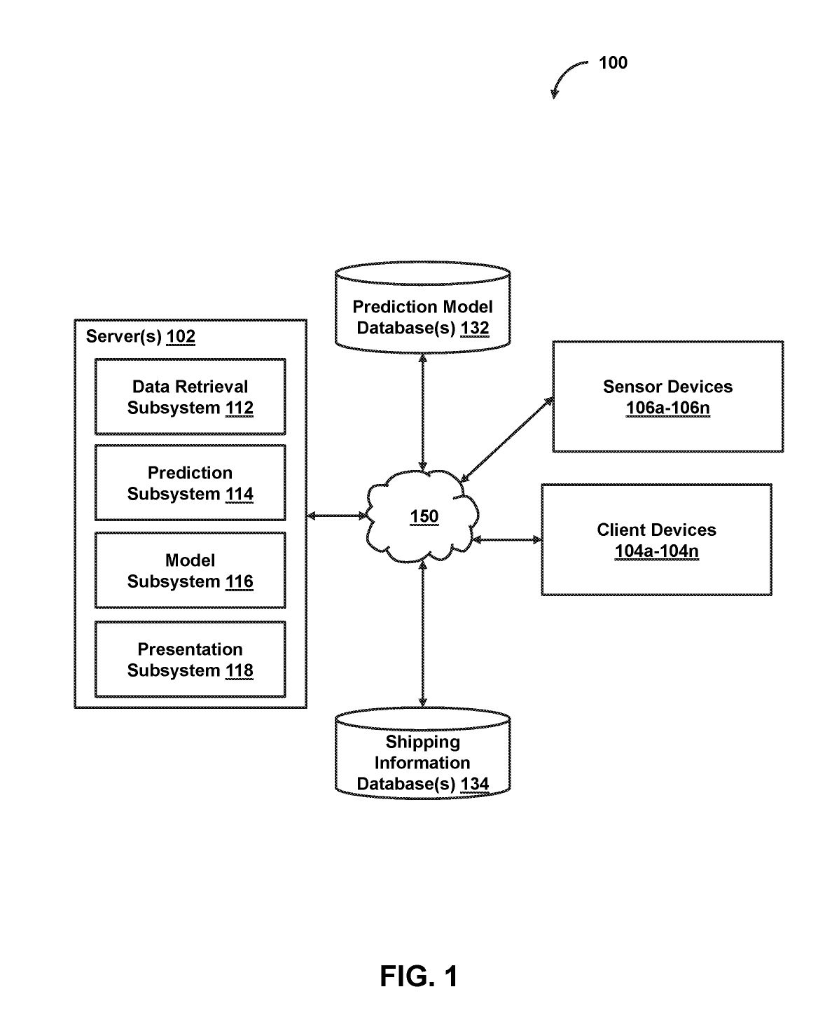

FIG. 1 shows a system 100 for facilitating tracking-related prediction for shipped containers or other items, in accordance with one or more embodiments. As discussed, traditional postal tracking computer systems enable their users (e.g., shippers of packages, recipients of packages, or other users) to access and view tracking information regarding their packages. Oftentimes, however, during a distribution center's processing of thousands of packages (as well as containers that each contain tracked packages) per day, the tracking barcodes (representing the tracking identifiers) of many such packages or other containers fail to be scanned, and, thus, no scan event indicating that those packages/containers arrived or departed the distribution center may be available, preventing the traditional postal tracking computer systems from providing their users with tracking information for those packages/containers with respect to that distribution center. When such packages/containers are shipped to a foreign country, the failure to scan may result in a long period of time during which users of the traditional postal tracking computer systems are unable to determine the current real status of their shipments (e.g., due to long delays resulting from customs or other reasons). The absence of additional information during such long time periods may lead to a poor user experience for customers of the shipper, customers of the postal carrier(s) delivering the packages/containers, and users of the postal tracking computer systems. As described herein, system 100 may facilitate tracking-related predictions to provide users with tracking information, for example, even when scan failures occur at one or more distribution centers or other locations at which packages/containers are to be scanned.

As shown in FIG. 1, system 100 may include server(s) 102, client devices 104 (or client devices 104a-104n), sensor devices 106 (or sensor devices 106a-106n), or other components. Server(s) 102 may include data retrieval subsystem 112, prediction subsystem 114, model subsystem 116, presentation subsystem 118, or other components. Each client device 104 may include any type of mobile terminal, fixed terminal, or other device. By way of example, client device 104 may include a desktop computer, a notebook computer, a tablet computer, a smartphone, a wearable device, or other client device. In some embodiments, one or more of the foregoing client devices 104 may include one or more sensor devices 106. Users may, for instance, utilize one or more client devices 104 to interact with one another, server(s) 102, sensor devices 106, or other components of system 100. Sensor devices 106 may include barcode readers (e.g., 2D or 3D barcode scanners), cameras, radio-frequency identification (RFID) readers, or other sensor devices. It should be noted that, while one or more operations are described herein as being performed by particular components of server(s) 102, those operations may, in some embodiments, be performed by other components of system 100. As an example, while one or more operations are described herein as being performed by components of server(s) 102, those operations may, in some embodiments, be performed by components of client device 104.

Tracking-Related Predictions

In some embodiments, system 100 may facilitate tracking-related prediction for shipped containers or other items. In some embodiments, a container may be a package that includes one or more shipped items. As an example, the container may be a tracked package or other tracked item (e.g., affixed with a tracking barcode or other representation of a tracking identifier, a postage indicia barcode or other representation of a postage indicia for the item, or other representation used for tracking the item). In some embodiments, a container may contain one or more containers in which one or more shipped items are contained. As an example, the container may be a tracked bag, a tracked pallet, a tracked box, or other container (e.g., with a tracking label) that contains one or more other tracked containers in which one or more shipped items are contained (e.g., where the items of the overall container are to be shipped to the same final destination or different final destinations). As another example, the container may contain a set of containers, where each container of the set of containers contains items that are to be shipped to a first location different from a second location that items contained in at least another container of the set of containers are to be shipped (e.g., a tracked bag or pallet may contain tracked packages that are to be shipped to different locations).

In some embodiments, system 100 may generate a prediction regarding a container or other item based on container/item shipping information, scan event information, routing information, or other information. The prediction may include (i) a prediction of which processing/distribution centers (or other places) the item has been or will be routed, (ii) an approximation of particular times at which the item is or will be located at respective locations (e.g., times of arrival at respective processing/distribution centers, times of departure from respective processing/distribution centers, etc.), (iii) an approximation of the total delivery time for the item or time of arrival of the item at its final destination, (iv) probabilities regarding the foregoing predictions, or (v) other prediction. As an example, system 100 may generate a prediction regarding the item being at a particular location, a prediction regarding the item being at a different location subsequent to the particular location, or other prediction. In some embodiments, the prediction may be generated without a scan event for the container occurring at the particular location or the subsequent location. Additionally, or alternatively, system 100 may not have obtained any user input (or other input) identifying that the container was actually at the particular location or the subsequent location at the time of the prediction (that the container was, is, or will be at the location or the subsequent location). As discussed below, in some embodiments, system 100 may use a prediction model to generate the prediction regarding the item, where the prediction is generated based on the foregoing information. It should be noted that, although some embodiments describe operations or other features for generating predictions regarding containers (e.g., shipped containers to be tracked), the operations/features may be utilized to generate predictions for other items (e.g., other shipped items to be tracked) in other embodiments to the extent possible.

Such information (on which a prediction is based) may include information related to items (e.g., containers or other items) that have reached its final destination at the time of the prediction, information related to items (e.g., containers or other items) that have not yet reached its final destination at the time of the prediction, or other information. The container/item shipping information may include information indicating (i) a destination associated with the item (e.g., the container), (ii) destinations associated with other items, (iii) an originating point associated with the item (e.g., the location of the initial scan of the item, the very first post office or other processing/distribution center at which the item is processed, etc.), (iv) originating points associated with other items, (v) a shipping service type associated with the item (e.g., Express Mail, Priority Mail, Priority Mail Flat Rate, First-Class Mail, Ground Shipping, Media Mail, or other shipping service type), (vi) shipping service types associated with other items, or (vii) other information. The scan event information may include information indicating one or more scan events that occurred at one or more locations, such as information identifying events identifiers for scan events (e.g., scans of containers or other items), cities, zip codes, or other location information corresponding to locations at which the scan events occurred, times at which the scan events occurred, tracking or other identifiers of containers scanned during the scan events, or other information. The routing information may include information indicating scheduled routes for shipping containers (or other items), predicted routes for shipping containers, actual routes taken to ship containers, or other information.

In some embodiments, data retrieval subsystem 112 may obtain container shipping information, scan event information, routing information, or other information (e.g., from shipping information database(s) 134, from sensor devices 106, or other data source). Prediction subsystem 114 may generate one or more predictions based on the foregoing information. Presentation subsystem 118 may cause the predictions to be presented at a user interface for presentation to one or more users. In some embodiments, data retrieval subsystem 112 may continuously obtain the foregoing information. As an example, data retrieval subsystem 112 may obtain the foregoing information on a periodic basis (e.g., periodically pulling or being pushed such information every 5 seconds or less, 30 seconds or less, 1 minute or less, every hour or less, every day or less, every week or less, etc.), in accordance with a schedule, or based on other automated triggers. In some embodiments, prediction subsystem 114 may continuously generate predictions (or update the predictions) based on the continuously obtained information (e.g., as the information is being obtained in real-time). As an example, prediction subsystem 114 may generate or update the predictions on a periodic basis (e.g., every 5 seconds or less, 30 seconds or less, 1 minute or less, every hour or less, every day or less, every week or less, etc.), in accordance with a schedule, or based on other automated triggers. In some cases, the periodic basis, schedule, or other automated triggers for the generation/updating of the predictions may be different from the periodic basis, schedule, or other automated triggers for the obtainment of the foregoing information. Presentation subsystem 118 may cause the presentation of the predictions to be updated based on the continuous generation/updating of the predictions (e.g., to provide a real-time presentation of the generated/updated predictions).

In some embodiments, prediction subsystem 114 may aggregate container shipping information, scan event information, routing information, or other information associated with containers or other items. Based on the aggregated information, prediction subsystem 114 may determine past averages (e.g., unweighted averages, weighted averages, etc.), probabilities of achieving the past averages, or other information. Past averages may include average times to ship items from one distribution center to the next distribution center, average times to ship items from the items' originating points to their final destinations, or other averages. In some embodiments, prediction subsystem 114 may generate one or more predictions based on the determined averages. As an example, such predictions regarding a shipped container or other item may include (i) a prediction of which processing/distribution centers (or other places) the item has been or will be routed, (ii) an approximation of particular times at which the item is or will be located at respective locations, (iii) an approximation of the total delivery time for the item or time of arrival of the item at its final destination, (iv) probabilities regarding the foregoing predictions, or (v) other predictions.

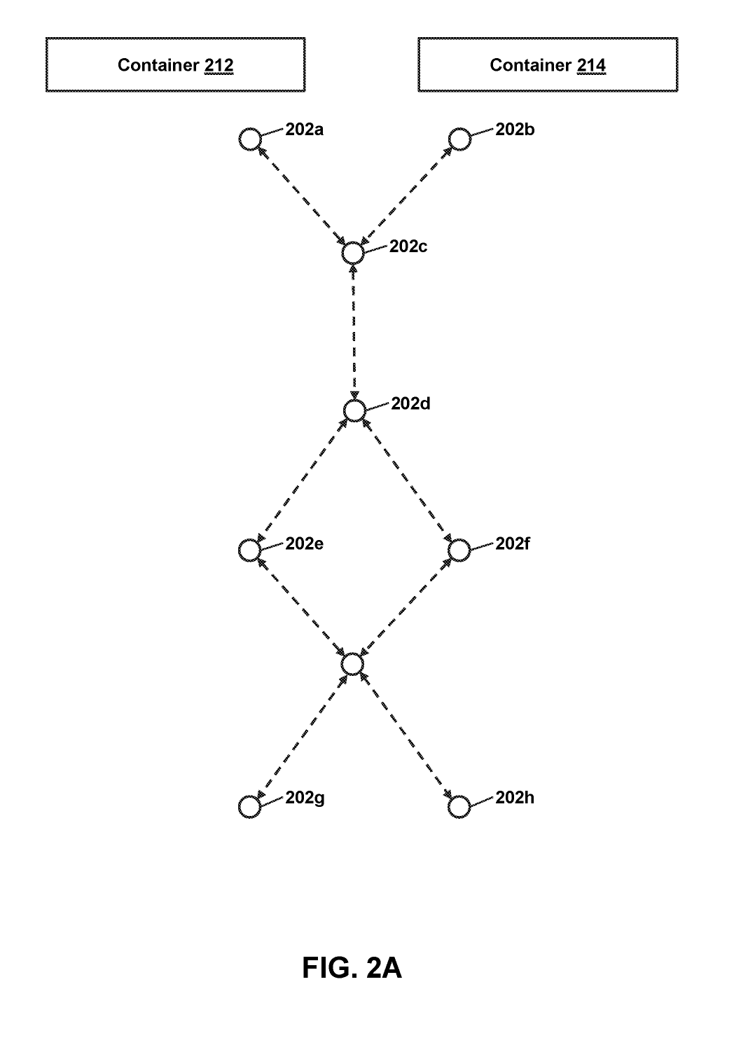

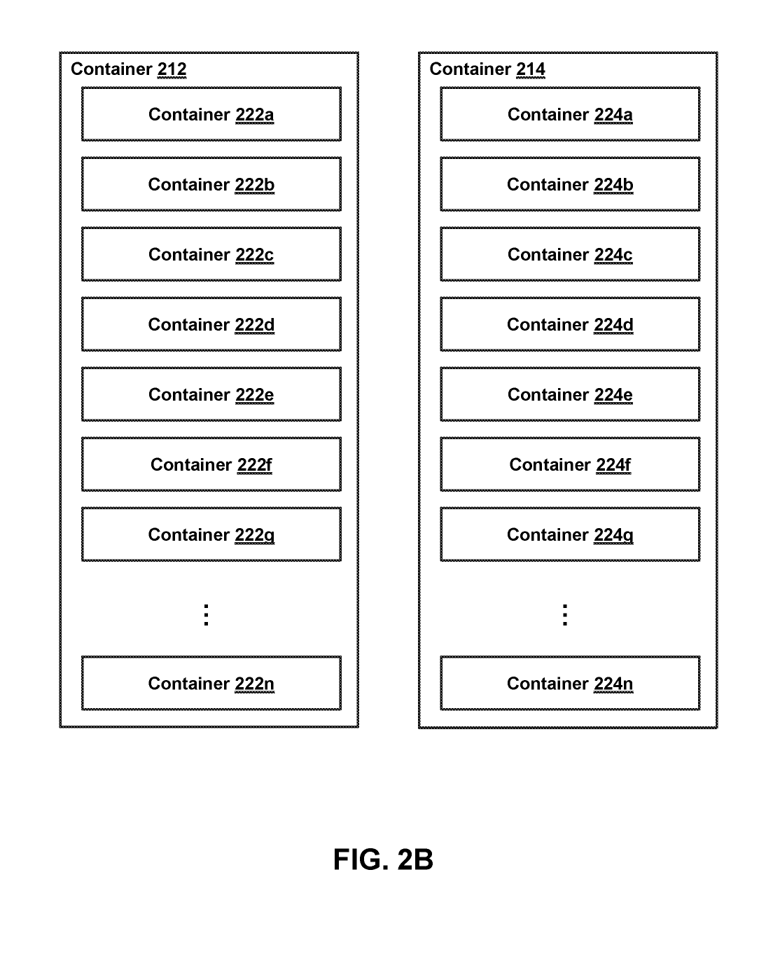

In some embodiments, prediction subsystem 114 may aggregate multiple sets of container shipping information, scan event information, routing information, or other information (associated with containers or other items) based on similarities of (i) shipping service types associated with the items, (ii) the originating points associated with the items, (iii) the destinations associated with the items, (iv) routes taken to ship the items, (v) dates/times at which the items are shipped (e.g., holiday vs. non-holiday, high volume seasons or periods vs. low volume seasons or periods, etc.), or (vi) other aspects of the items. Prediction subsystem 114 may determine multiple sets of averages based on the sets of aggregated information, respectively, such that one of the sets of averages are determined from one of the sets of aggregated information and another one of the sets of averages are determined from another one of the sets of aggregated information. As an example, with respect to FIG. 2, (i) a first set of aggregated information may be aggregated from obtained information for items associated with a shipping type that is the same as or similar to a first shipping type and scanned at two or more locations (e.g., locations 202a and 202c, an originating distribution center at which an item originates to a final distribution center from which the item is delivered to the receipt, or other locations), (ii) a second set of aggregated information may be aggregated from the obtained information for items associated with a shipping service type that is the same as or similar to a second shipping type and scanned at the two or more locations, (iii) a second set of aggregated information may be aggregated from the obtained information for items associated with a shipping service type that is the same as or similar to a third shipping type and scanned at the two or more locations, and (iv) so on. Prediction subsystem 114 may determine (i) a first set of averages for shipping items associated with a shipping service type that is the same or similar to the first shipping service type (e.g., an average amount of time to ship an item from a first location to a second location, an average amount of time to ship an item from the second location to the first location, respective probabilities that an item will ship between locations 202a and 202c in the foregoing average amounts of time, etc.) based on the first set of aggregated information, (ii) a second set of averages for shipping items associated with a shipping service type that is the same or similar to the second shipping service type based on the second set of aggregated information, (iii) a third set of averages for shipping items associated with a shipping service type that is the same or similar to the third shipping service type based on the third set of aggregated information, and (iv) so on.

As another example, respective sets of aggregated information may be aggregated from obtained information for items shipped during similar volume seasons or periods (e.g., for items shipped during the Christmas season, for items shipped after the Christmas season, for items shipped during a similar low volume season or period, etc.) (e.g., in addition or alternatively to the shipping service type criteria or scan location criteria described above). Prediction subsystem 114 may determine sets of averages for shipping items that are to be shipped during similar volume seasons or periods respectively based on the sets of aggregated information. Prediction subsystem 114 may generate one or more predictions based on the determined averages (e.g., predictions regarding a shipped container or other item as described herein).

Model-Based Tracking-Related Predictions

In some embodiments, system 100 may use a prediction model to generate a prediction regarding a container (or other item) being at a particular location (e.g., a time of arrival at the location, a time of departure from the location, etc.), a prediction regarding the container being at a different location subsequent to the particular location (e.g., a time of arrival at the subsequent location, a time of departure from the subsequent location, etc.), or other prediction. In some embodiments, the prediction may be generated using the prediction model without a scan event for the container occurring at the particular location. As an example, when the prediction (e.g., that the container was, is, or will be at the location) is generated, no scan event for the container has occurred at the location (e.g., the container has not been scanned at the location) or some other issue occurred that prevented scan event information for the container at the location from being obtained. Additionally, or alternatively, system 100 may not have obtained any user input (or other input) identifying that the container was actually at the location at the time of the prediction (that the container was, is, or will be at the location). The prediction model used to generate the prediction model may be a neural network or other prediction model (e.g., machine-learning-based prediction model or other prediction model).

In some embodiments, a neutral network may be trained and utilized for predicting (i) which processing/distribution centers (or other locations) a container (or other item) has been or will be routed, (ii) particular times at which the container is or will be located at respective locations, (iii) the total delivery time for the container or time of arrival of the container at its final destination, (iv) probabilities regarding the foregoing predictions, or (v) other information. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neutral unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

In some embodiments, system 100 may facilitate training of a neural network or other prediction model to generate predictions regarding one or more containers (or other items). In some embodiments, data retrieval subsystem 112 may obtain container shipping information, scan event information, routing information, or other information (e.g., from shipping database(s) 134, from sensor devices 106, or other data source). The obtained information may include historical information (e.g., including information for containers that have been delivered to their final destinations), real-time information (e.g., including information for containers that have not yet been delivered to their final destinations), or other information. Model subsystem 116 may provide the obtained information as input to a neural network or other prediction model (e.g., as parameters or other type of input) to train the prediction model to predict shipping-related events. As an example, the scan event information may include information regarding 500 or more scan events, 1000 or more scan events, 10000 or more scan events, 100000 or more scan events, 1000000 or more scan events, or other number of scan events, where each of the scan events corresponds to a scan of a container at a processing/distribution center or other location (e.g., a pick-up location, the final destination, etc.). The container shipping information may include information indicating, for each container for which at least one of the scan events (e.g., the 500-1000000 or more scan events) has occurred at a processing/distribution center or other location, (i) a destination associated with the container, (ii) a shipping service type associated with the container, (iii) an originating point associated with the container, or (iv) other information. The routing information may include information indicating, for each container for which at least one of the scan events (e.g., the 500-1000000 or more scan events) has occurred at a processing/distribution center or other location, (i) a scheduled route for the container, (ii) a predicted route for the container (e.g., a route predicted dynamically based on prior routes taken by containers associated with similar aspects described herein), (iii) an actual route taken to ship the container, or (iv) other information.

In some embodiments, a neural network or other prediction model may be configured to apply one or more rules to its processing/analysis of information (e.g., information provided as input to train or update the prediction model or other information), such as (i) rules applying static or dynamic thresholds to identify and reduce the effect of outliers when training or updating itself (e.g., by giving outlier data outside a static or dynamic threshold range less weight compared to data within the threshold range, by giving such outlier data no weight, etc.), (ii) rules for considering seasonality or abnormal time periods, (iii) rules for generating notifications (e.g., automated notifications in response to the prediction model predicting a shipment to be late or other notifications), or (iv) other rules. In some embodiments, the prediction model may be configured to aggregate container shipping information, scan event information, routing information, or other information associated with containers or other items, and determine averages based on the aggregated information (e.g., in a same or similar manner as described herein with respect to operations of prediction subsystem 114).

In some embodiments, data retrieval subsystem 112 may obtain container shipping information, scan event information, routing information, or other information regarding a first container and a second container (or other containers). Prediction subsystem 114 may use a neural network or other prediction model (e.g., a prediction model trained as described herein) to generate a prediction regarding a container (or other item) being at a particular location, a prediction regarding the container being at a different location subsequent to the particular location, or other prediction. In some embodiments, the prediction may be generated using the prediction model without a scan event for the container occurring at the particular location. Additionally, or alternatively, the prediction may be generated using the prediction model without a scan event for the container occurring at the subsequent location.

In some embodiments, the container shipping information may include information indicating a first destination associated with the first container, a second destination associated with the second container, a first originating point associated with the first container, a second originating point associated with the second container, a first shipping service type associated with the first container, a second shipping service type associated with the second container, or other information. The scan event information may include information indicating a first-location scan event associated with the first container that occurred at a first location, a first-location scan event associated with the second container that occurred at the first location, and a second-location scan event associated with the first container that occurred at a second location. Prediction subsystem 114 may use the prediction model to generate a prediction regarding (i) the second container being at the second location subsequent to being at the first location, (ii) a prediction regarding the second container being at a third location subsequent to being at the second location, or (iii) other prediction. As an example, when the prediction (e.g., that the second container was, is, or will be at the second location or the third location) is generated, no scan event for the second container has occurred at the second location or the third location (e.g., the second container has not been scanned at the second location or the third location). Additionally, or alternatively, prediction subsystem 114 may not have obtained any user input (or other input) identifying that the second container was actually at the second location or the third location at the time of the prediction (e.g., that the second container was, is, or will be at the second location or the third location). Prediction subsystem 114 may, for example, provide the container shipping information and the scan event information (or other information) as input to the prediction model (e.g., as parameters or other type of input) to cause the prediction model to generate the prediction regarding the second container. The prediction model may output the prediction regarding the second container based on the (i) the first container being associated with the first destination, (ii) the second container being associated with the second destination, (iii) the first-location scan event associated with the first container, (iv) the first-location scan event being associated with the second container, (v) the second-location scan event being associated with the first container, or (vi) other information.

In one use case, with respect to FIG. 2A, (i) first and second containers 212 and 214 (e.g., first and second tracked packages, first and second tracked bags that each contain one or more tracked packages, etc.) may be associated with the same or similar shipping service type (e.g., both are Priority Mail, both containers 212 and 214 are associated with shipping services having the same average shipping times, etc.), (ii) the originating processing/distribution center of first container 212 may be location 202a, (iii) the originating processing/distribution center of the second container 214 may be location 202b, and (iv) the final processing/distribution center of the first and second containers 212 and 214 may be location 202e (e.g., prior to the first and second containers 212 and 214 being respectively delivered to their intended recipients). Alternatively, the final processing/distribution center of first container 212 may be location 202e prior to first container 212 being respectively delivered to its intended recipient, and the final processing/distribution center of the second container 214 may be location 202f (e.g., prior to the second container 214 being respectively delivered to its intended recipient).

With respect to the foregoing use case, based on the origination/destination/service type information and routing information indicating that containers originating from locations 202a and 202b and destined for locations 202e and 202f are to be routed through locations 202c and 202d, a prediction model (e.g., a neural network) may generate a prediction that the first and second containers 212 and 214 will arrive and depart at location 202c at a similar time (e.g., the same day, within hours of one another, etc.) and at location 202d at a similar time. As an example, if first container 212 is scanned at location 202c to signal its arrival at location 202c, information regarding the scan event occurring at location 202c may be transmitted by a computer system (e.g., a client device, server, etc.) at location 202c to server(s) 102 (or shipping information database(s) 134 or other data storage). Such scan event information may include information identifying an event identifier for the scan event, city, zip code, or other location information (e.g., identifier of processing/distribution center) corresponding to location 202c, the time at which the scan event occurred, tracking or other identifier of the first container, or other information. Prediction subsystem 102 may provide the scan event information to the prediction model. Even if the second container 214 is not scanned at location 202c (and no information identifying the second container 214 as being at location 202c is obtained by the prediction model), the prediction model may generate a prediction that the second container 214 arrived at location 202c at about the time of the scan event (of the first container) based on (i) a determination that first container 212 was scanned at location 202c and (ii) its prediction that the first and second containers 212 and 214 will arrive at location 202c at a similar time.

As another example, if both the first and second containers 212 and 214 are scanned at location 202c at about the same time to signal their arrival at location 202c, information regarding the scan events (for the two containers 212 and 214) occurring at location 202c may be transmitted by a computer system at location 202c to server(s) 102, and prediction subsystem 102 may provide the scan event information to the prediction model. Based on both the first and second containers 212 and 214 being scanned at location 202c at about the same time, the prediction model may increase its estimated probability that both the first and second containers 212 and 214 will arrive at location 202d at about the same time. As such, if first container 212 is scanned at location 202d to signal its arrival at location 202d, information regarding the scan event occurring at location 202d may be transmitted by a computer system at location 202d to server(s) 102, and prediction subsystem 114 may provide the scan event information to the prediction model. Even if the second container 214 is not scanned at location 20dc (and no information identifying the second container 214 as being at location 202d is obtained by the prediction model), the prediction model may generate a prediction that the second container 214 arrived at location 202d at about the time of the scan event (of the first container) based on (i) a determination that the first and second containers 212 and 214 was scanned at location 202c, (ii) a determination that first container 212 was scanned at location 202d, and (ii) its increased estimated probability that the first and second containers 212 and 214 will arrive at location 202d at a similar time.

In another use case, with respect to FIG. 2A, based on the origination/destination/service type information, the prediction model may generate a prediction of one or more routes to be taken to ship first and second containers 212 and 214. As an example, the prediction of the routes for first and second containers 212 and 214 may be based on (i) the shipping service types associated with first and second containers 212 and 214, (ii) the originating points associated with first and second containers 212 and 214, (iii) the destinations associated with first and second containers 212 and 214, (iv) dates/times at which first and second containers 212 and 214 are shipped, or (vi) other aspects of first and second containers 212 and 214. The route prediction for first container 212 may be based on past routes taken to ship prior containers (i) associated with the same or similar shipping service types as the shipping service type associated with first container 212, (ii) associated with the same or similar originating points as the originating point associated with first container 212, (iii) associated with the same or similar destinations as a destination associated with first container 212, (iv) shipped at similar dates/times relative to a given year as the date/time the first container 212 was shipped, or (iv) the like. The route prediction for second container 214 may be based on past routes taken to ship prior containers (i) associated with the same or similar shipping service types as the shipping service type associated with second container 214, (ii) associated with the same or similar originating points as the originating point associated with second container 214, (iii) associated with the same or similar destinations as a destination associated with second container 214, (iv) shipped at similar dates/times relative to a given year as the date/time the second container 214 was shipped, or (iv) the like. If, for example, the predicted routes for both containers 212 and 214 include one or more same locations, the prediction model may generate a prediction that first and second containers 212 and 214 will respectively arrive and depart those particular locations at similar times (e.g., the same day, within hours of one another, etc.).

In a further use case, with respect to FIG. 2B, first container 212 may be a tracked container (e.g., a tracked bag, box, etc.) that contains tracked containers 222a-222n, and second container 214 may be a tracked container that contains tracked containers 224a-224n. As an example, first container 212 may be a container affixed with a first tracking barcode or other representation of a first tracking identifier, and second container 214 may be a container affixed with a second tracking barcode or other representation of a second tracking identifier. Each of the containers 222a-222n may be affixed with tracking barcodes or other representation of tracking identifiers that are different from one another and the first tracking barcode/representation. Each of the containers 224a-224n may be affixed with tracking barcodes or other representation of tracking identifiers that are different from one another and the second tracking barcode/representation. To facilitate tracking of containers 222a-222n and 224a-224n, the tracking identifiers of containers 222a-222n are stored in association with the tracking identifier of first container 212, and the tracking identifiers of containers 224a-224n are stored in association with the tracking identifier of second container 214. As such, tracking-related predictions made for first container 212 may be applied to containers 222a-222n (e.g., a prediction that first container 212 has arrived at a particular location results in a prediction that containers 222a-222n arrived at the location). Moreover, tracking-related predictions made for second container 214 may be applied to containers 224a-224n.

Examples Flowcharts

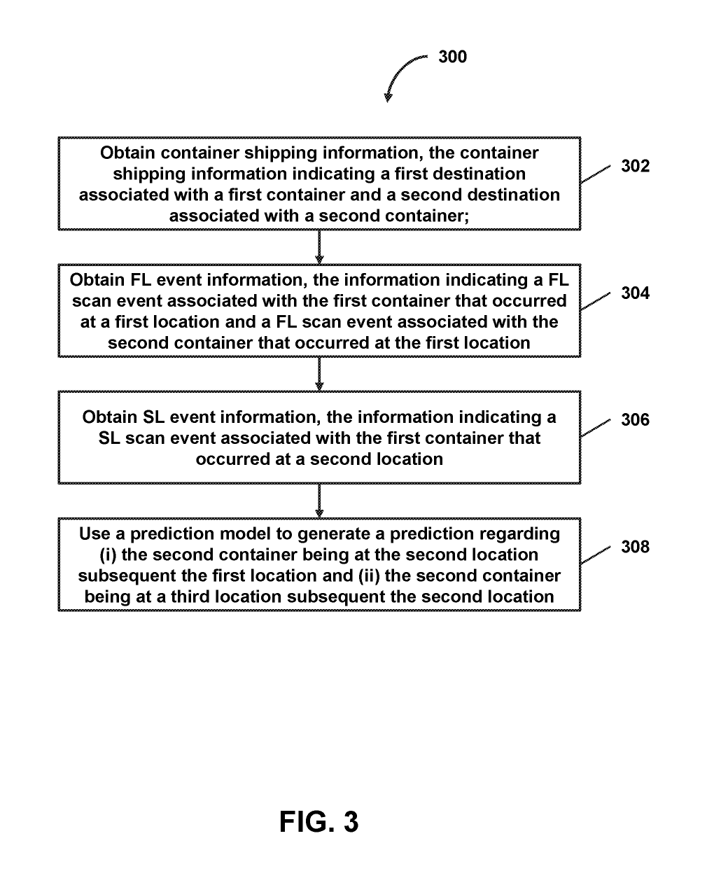

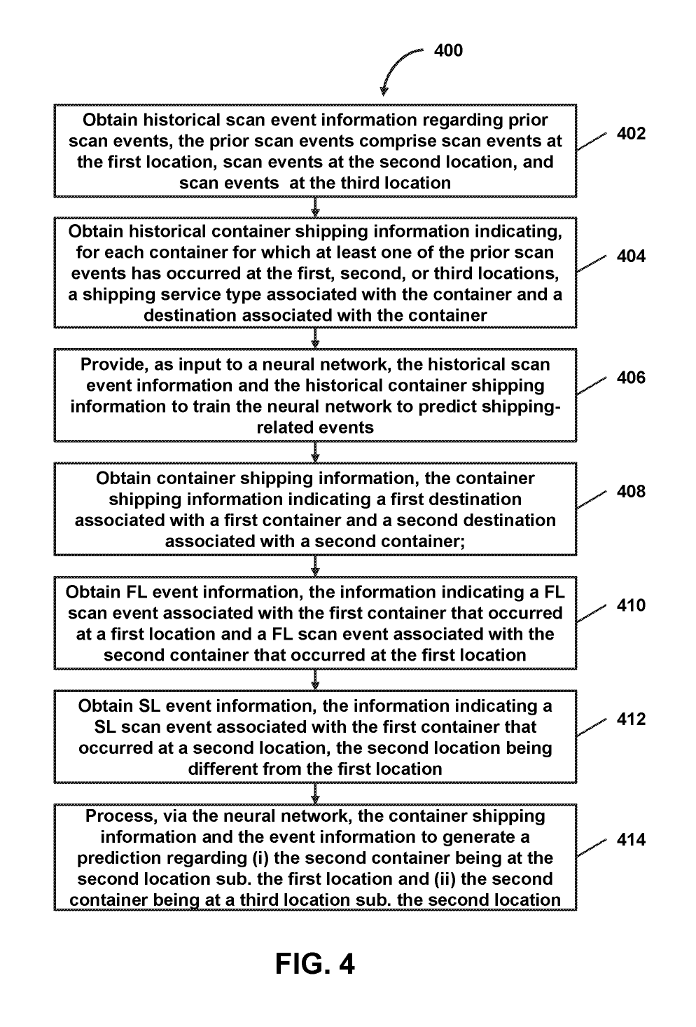

FIGS. 3 and 4 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 3 shows a flowchart of a method 300 of facilitating model-based tracking-related prediction for shipped containers, in accordance with one or more embodiments. In an operation 302, container shipping information may be obtained. As an example, the container shipping information may indicate a first destination associated with a first container and a second destination associated with a second container (e.g., information identifying respective destination addresses to which the containers are to be shipped or other information). In one use case, a container may be a package that includes one or more shipped items. The container may, for example, be a tracked package or other tracked item (e.g., affixed with a tracking barcode or other representation of a tracking identifier, a postage indicia barcode or other representation of a postage indicia for the item, or other representation used for tracking the item). In another use case, a container may contain one or more containers in which one or more shipped items are contained. The container may, for example, be a tracked bag, a tracked pallet, a tracked box, or other container that contains one or more other tracked containers in which one or more shipped items are contained (e.g., where the items of the overall container are to be shipped to the same final destination or different final destinations). As another example, the container may contain a set of containers, where each container of the set of containers contains items that are to be shipped to a first location different from a second location that items contained in at least another container of the set of containers are to be shipped (e.g., a tracked bag or pallet may contain tracked packages that are to be shipped to different locations). Operation 302 may be performed by a subsystem that is the same as or similar to data retrieval subsystem 112, in accordance with one or more embodiments.

In an operation 304, first-location event information may be obtained. As an example, the first-location event information may indicate a first-location scan event associated with the first container that occurred at a first location and a first-location scan event associated with the second container that occurred at the first location (e.g., information identifying events identifiers for scan events, cities, zip codes, or other location information corresponding to locations at which the scan events occurred, times at which the scan events occurred, tracking or other identifiers of containers scanned during the scan events, or other information). Operation 304 may be performed by a subsystem that is the same as or similar to data retrieval subsystem 112, in accordance with one or more embodiments.

In an operation 306, second-location event information may be obtained. As an example, second-location event information may indicate a second-location scan event associated with the first container that occurred at a second location (e.g., information identifying events identifiers for the scan event, the place, city, zip code, or other location information corresponding to the second location as a location at which the scan event occurred, tracking or other identifier of the second container, or other information). Operation 306 may be performed by a subsystem that is the same as or similar to data retrieval subsystem 112, in accordance with one or more embodiments.

In an operation 308, a prediction model may be used to generate a prediction regarding the second container. As an example, the prediction may include a prediction regarding (i) the second container being at the second container being at the second location subsequent to being at the first location and (ii) the second container being at a third location subsequent to being at the second location. As an example, the prediction may be generated without a scan event for the second container occurring at the second location. As another example, the prediction may be generated without a scan event for the second container occurring at the third location. As another example, the prediction regarding the second container may be generated, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container. Operation 308 may be performed by a subsystem that is the same as or similar to prediction subsystem 116, in accordance with one or more embodiments.

FIG. 4 shows a flowchart of a method 400 of facilitating neural-network-based tracking-related prediction for shipped containers, in accordance with one or more embodiments. In an operation 402, historical scan event information regarding prior scan events may be obtained. As an example, each of the prior scan events may be for a container that has been delivered to its final destination. The prior scan events may comprise a first set of prior scan events occurring at the first location, a second set of prior scan events occurring at the second location, and a third set of prior scan events occurring at the third location. Operation 402 may be performed by a subsystem that is the same as or similar to data retrieval subsystem 112, in accordance with one or more embodiments.

In an operation 404, historical container shipping information may be obtained. As an example, the historical container shipping information may indicate, for each container for which at least one of the prior scan events has occurred at the first, second, or third locations, a shipping service type associated with the container and a destination associated with the container. Operation 404 may be performed by a subsystem that is the same as or similar to data retrieval subsystem 112, in accordance with one or more embodiments.

In an operation 406, the historical scan event information (including the first, second, and third sets of prior scan events) and the historical container shipping information (including the associated shipping service types and the associated destinations) may be provided as input to a neural network to train the neural network to predict shipping-related events. Operation 406 may be performed by a subsystem that is the same as or similar to model subsystem 114, in accordance with one or more embodiments.

In an operation 408, container shipping information may be obtained. As an example, the container shipping information may indicate a first destination associated with a first container and a second destination associated with a second container (e.g., information identifying respective destination addresses to which the containers are to be shipped or other information). Operation 408 may be performed by a subsystem that is the same as or similar to data retrieval subsystem 112, in accordance with one or more embodiments.

In an operation 410, first-location event information may be obtained. As an example, the first-location event information may indicate a first-location scan event associated with the first container that occurred at a first location and a first-location scan event associated with the second container that occurred at the first location (e.g., information identifying events identifiers for scan events, cities, zip codes, or other location information corresponding to locations at which the scan events occurred, times at which the scan events occurred, tracking or other identifiers of containers scanned during the scan events, or other information). Operation 410 may be performed by a subsystem that is the same as or similar to data retrieval subsystem 112, in accordance with one or more embodiments.

In an operation 412, second-location event information may be obtained. As an example, second-location event information may indicate a second-location scan event associated with the first container that occurred at a second location (e.g., information identifying events identifiers for the scan event, the place, city, zip code, or other location information corresponding to the second location as a location at which the scan event occurred, tracking or other identifier of the second container, or other information). Operation 412 may be performed by a subsystem that is the same as or similar to data retrieval subsystem 112, in accordance with one or more embodiments.

In an operation 414, the container shipping information and the event information (i.e., the first-location and second-location event information) may be processed via the neural network to generate a prediction regarding the second container. As an example, the prediction may include a prediction regarding (i) the second container being at the second container being at the second location subsequent to being at the first location and (ii) the second container being at a third location subsequent to being at the second location. As an example, the prediction may be generated without a scan event for the second container occurring at the second location. As another example, the prediction may be generated without a scan event for the second container occurring at the third location. As another example, the prediction regarding the second container may be generated, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container. Operation 414 may be performed by a subsystem that is the same as or similar to prediction subsystem 116, in accordance with one or more embodiments.

In some embodiments, the various computers and subsystems illustrated in FIG. 1 may include one or more computing devices that are programmed to perform the functions described herein. The computing devices may include one or more electronic storages (e.g., prediction model database(s) 132, shipping information database(s) 134, or other electric storages), one or more physical processors programmed with one or more computer program instructions, and/or other components. The computing devices may include communication lines or ports to enable the exchange of information with a network (e.g., network 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-118 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-118 described herein is for illustrative purposes, and is not intended to be limiting, as any of subsystems 112-118 may provide more or less functionality than is described. For example, one or more of subsystems 112-118 may be eliminated, and some or all of its functionality may be provided by other ones of subsystems 112-118. As another example, additional subsystems may be programmed to perform some or all of the functionality attributed herein to one of subsystems 112-118.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A method comprising: obtaining container shipping information, the container shipping information indicating a first destination associated with a first container and a second destination associated with a second container; obtaining first-location event information, the first-location event information indicating a first-location scan event associated with the first container that occurred at a first location and a first-location scan event associated with the second container that occurred at the first location; obtaining second-location event information, the second-location event information indicating a second-location scan event associated with the first container that occurred at a second location different from the first location; and using, without a second-location scan event for the second container occurring at the second location, a prediction model to generate a prediction regarding (i) the second container being at the second location subsequent to being at the first location and (ii) the second container being at a third location subsequent to being at the second location, the third location being different from the first and second locations, wherein the prediction regarding the second container is generated, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.
2. The method of embodiment 1, wherein the first and second containers each contain one or more containers in which one or more shipped items are contained.
3. The method of embodiments 1 or 2, wherein the generated prediction is an approximation of a time at which the second container is located at the second location and a future time at which the second container will be located at the third location, wherein the approximation is performed, using the prediction model, without a second-location scan event for the second container occurring at the second location, and wherein the approximation is performed, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.
4. The method of any of embodiments 1-3, further comprising: predicting a first shipping route for the first container based on the first container being associated with the first destination, the predicted first shipping route comprising the first location and the second location; and predicting a second shipping route for the second container based on the second container being associated with the second destination, the predicted second shipping route comprising the first location, the second location, and the third location, wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the predicted first and second shipping routes each comprising the first location and the second location.
5. The method of any of embodiments 1-4, wherein the container shipping information indicates a first shipping service type associated with the first container and a second shipping service type associated with the second container, and wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the first container being associated with the first shipping service type, and (vii) the second container being associated with the second shipping service type.
6. The method of embodiment 5, wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, (vi) the first container being associated with the first shipping type and the second container being associated with the second shipping type, and (vii) a determination of a relatedness between the first and second shipping service types.
7. The method of any of embodiments 1-6, further comprising: obtaining scan event information regarding scan events, each of the scan events being for a container that has not yet been delivered to its final destination, the scan events comprise a first set of scan events occurring at the first location, a second set of scan events occurring at the second location, and a third set of scan events occurring at the third location, wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the scan event information comprising the first, second, and third sets of scan events.
8. The method of embodiment 7, wherein the container shipping information indicates, for each container for which at least one of the scan events has occurred at the first, second, or third locations, a shipping service type associated with the container, and wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, (vi) the scan event information comprising the first, second, and third sets of scan events, and (vii) the shipping services types associated with the containers for which the scan events has occurred.
9. The method of embodiment 1, further comprising: obtaining historical scan event information regarding prior scan events, each of the scan events being for a container that has been delivered to its final destination, the prior scan events comprise a first set of prior scan events occurring at the first location, a second set of prior scan events occurring at the second location, and a third set of prior scan events occurring at the third location, wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the historical scan event information comprising the first, second, and third sets of prior scan events.
10. A method comprising: obtaining historical scan event information regarding at least 1000 prior scan events, each of the 1000 prior scan events being for a container that has been delivered to its final destination, the 1000 prior scan events comprise a first set of prior scan events occurring at the first location, a second set of prior scan events occurring at the second location, and a third set of prior scan events occurring at the third location; obtaining historical container shipping information, the historical container shipping information indicating, for each container for which at least one of the 1000 prior scan events has occurred at the first, second, or third locations, a shipping service type associated with the container and a destination associated with the container; providing, as input to a neural network, (i) the historical scan event information comprising the first, second, and third sets of prior scan events and (ii) the historical container shipping information comprising the associated shipping service types and the associated destinations to train the neural network to predict shipping-related events; obtaining container shipping information, the container shipping information indicating a first destination associated with a first container and a second destination associated with a second container; obtaining scan event information, the scan event information indicating a first-location scan event associated with the first container that occurred at a first location, a first-location scan event associated with the second container that occurred at the first location, and a second-location scan event associated with the first container that occurred at a second location different from the first location; and processing, via the neural network, without a second-location scan event for the second container occurring at the second location, the container shipping information and the scan event information to generate a prediction regarding (i) the second container being at the second location subsequent to being at the first location and (ii) the second container being at a third location different from the first and second location subsequent to being at the second location, wherein the prediction regarding the second container is generated, using the neural network, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.
11. The method of embodiment 10, further comprising: obtaining further scan event information regarding at least 1000 further scan events, each of the 1000 further scan events being for a container that has not yet been delivered to its final destination, the 1000 further scan events comprise a first set of further scan events occurring at the first location, a second set of further scan events occurring at the second location, and a third set of further scan events occurring at the third location; obtaining further container shipping information, the further container shipping information indicating, for each container for which at least one of the 1000 further scan events has occurred at the first, second, or third locations, a shipping service type associated with the container and a destination associated with the container; and providing, as input to the neural network, (i) the further scan event information comprising the first, second, and third sets of further scan events and (ii) the further container shipping information comprising the associated shipping service types and the associated destinations to train the neural network to predict shipping-related events.
12. The method of embodiment 11, wherein the obtainment of the further scan event information, the obtainment of the further container shipping information, and the providing of the further scan event information and the further container shipping information is continuously performed to continuously update the neural network.
13. The method of any of embodiments 10-12, wherein the first and second containers each contain one or more containers in which one or more shipped items are contained.
14. The method of any of embodiments 10-13, wherein the generated prediction is an approximation of a time at which the second container is located at the second location and a future time at which the second container will be located at the third location, wherein the approximation is performed, using the neural network, without a second-location scan event for the second container occurring at the second location, and wherein the approximation is performed, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.
15. The method of any of embodiments 10-14, wherein the computer system is further caused to: predict a first shipping route for the first container based on the first container being associated with the first destination, the predicted first shipping route comprising the first location and the second location; and predict a second shipping route for the second container based on the second container being associated with the second destination, the predicted second shipping route comprising the first location, the second location, and the third location, wherein the prediction regarding the second container is generated, using the neural network, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the predicted first and second shipping routes each comprising the first location and the second location.
16. The method of any of embodiments 10-15, wherein the container shipping information indicates a first shipping service type associated with the first container and a second shipping service type associated with the second container, and wherein the prediction regarding the second container is generated, using the neural network, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the first container being associated with the first shipping service type, and (vii) the second container being associated with the second shipping service type.
17. A tangible, non-transitory, machine-readable medium storing instructions that when executed by a data processing apparatus cause the data processing apparatus to perform operations comprising those of any of embodiments 1-16.
18. A system, comprising: one or more processors; and memory storing instructions that when executed by the processors cause the processors to effectuate operations comprising those of any of embodiments 1-16.

What is claimed is:

1. A system for facilitating model-based tracking-related prediction for shipped containers, the system comprising:
a computer system that comprises one or more processors programmed with computer program instructions that, when executed, cause the customer computer system to:
obtain historical scan event information regarding at least 1000 prior scan events, each of the at least 1000 prior scan events being for one or more containers that have been delivered to their final destination, the at least 1000 prior scan events comprise a first set of prior scan events occurring at a first location, a second set of prior scan events occurring at a second location, and a third set of prior scan events occurring at a third location;
obtain historical container shipping information, the historical container shipping information indicating, for each container for which at least one of the at least 1000 prior scan events has occurred at the first, second, or third locations, a shipping service type associated with the container and a destination associated with the container;
provide, as input to a neural network, (i) the historical scan event information comprising the first, second, and third sets of prior scan events and (ii) the historical container shipping information comprising the associated shipping service types and the associated destinations to train the neural network to predict shipping-related events;
obtain container shipping information, the container shipping information indicating a first destination associated with a first container and a second destination associated with a second container;
obtain scan event information, the scan event information indicating a first-location scan event associated with the first container that occurred at a first location, a first-location scan event associated with the second container that occurred at the first location, and a second-location scan event associated with the first container that occurred at a second location different from the first location; and
process, via the neural network, without a second-location scan event for the second container occurring at the second location, the container shipping information and the scan event information to generate a prediction regarding (i) the second container being at the second location subsequent to being at the first location and (ii) the second container being at a third location different from the first and second location subsequent to being at the second location,
wherein the prediction regarding the second container is generated, using the neural network, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

2. The system of claim 1, wherein the computer system is further caused to:
obtain further scan event information regarding at least 1000 further scan events, each of the at least 1000 further scan events being for a container that has not yet been delivered to its final destination, the at least 1000 further scan events comprise a first set of further scan events occurring at the first location, a second set of further scan events occurring at the second location, and a third set of further scan events occurring at the third location;
obtain further container shipping information, the further container shipping information indicating, for each container for which at least one of the at least 1000 further scan events has occurred at the first, second, or third locations, a shipping service type associated with the container and a destination associated with the container; and
provide, as input to the neural network, (i) the further scan event information comprising the first, second, and third sets of further scan events and (ii) the further container shipping information comprising the associated shipping service types and the associated destinations to train the neural network to predict shipping-related events.

3. The system of claim 2, wherein the obtainment of the further scan event information, the obtainment of the further container shipping information, and the providing of the further scan event information and the further container shipping information is continuously performed to continuously update the neural network

4. The system of claim 1, wherein the first and second containers each contain one or more containers in which one or more shipped items are contained.

5. The system of claim 1, wherein the generated prediction is an approximation of a time at which the second container is located at the second location and a future time at which the second container will be located at the third location,
wherein the approximation is performed, using the neural network, without a second-location scan event for the second container occurring at the second location, and
wherein the approximation is performed, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

6. The system of claim 1, wherein the computer system is further caused to:
predict a first shipping route for the first container based on the first container being associated with the first destination, the predicted first shipping route comprising the first location and the second location; and
predict a second shipping route for the second container based on the second container being associated with the second destination, the predicted second shipping route comprising the first location, the second location, and the third location,
wherein the prediction regarding the second container is generated, using the neural network, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the predicted first and second shipping routes each comprising the first location and the second location.

7. The system of claim 1, wherein the container shipping information indicates a first shipping service type associated with the first container and a second shipping service type associated with the second container, and
wherein the prediction regarding the second container is generated, using the neural network, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the first container being associated with the first shipping service type, and (vii) the second container being associated with the second shipping service type.

8. A method of facilitating model-based tracking-related prediction for shipped containers, the method being implemented by a computer system comprising one or more processors executing computer program instructions that, when executed, perform the method, the method comprising:
obtaining container shipping information, the container shipping information indicating a first destination associated with a first container and a second destination associated with a second container;
obtaining first-location event information, the first-location event information indicating a first-location scan event associated with the first container that occurred at a first location and a first-location scan event associated with the second container that occurred at the first location;
obtaining second-location event information, the second-location event information indicating a second-location scan event associated with the first container that occurred at a second location different from the first location; and
using, without a second-location scan event for the second container occurring at the second location, a prediction model to generate a prediction regarding (i) the second container being at the second location subsequent to being at the first location and (ii) the second container being at a third location subsequent to being at the second location, the third location being different from the first and second locations,
wherein the prediction regarding the second container is generated, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

9. The method of claim 8, wherein the first and second containers each contain one or more containers in which one or more shipped items are contained.

10. The method of claim 8, wherein the generated prediction is an approximation of a time at which the second container is located at the second location and a future time at which the second container will be located at the third location,
wherein the approximation is performed, using the prediction model, without a second-location scan event for the second container occurring at the second location, and
wherein the approximation is performed, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

11. The method of claim 8, further comprising:
predicting a first shipping route for the first container based on the first container being associated with the first destination, the predicted first shipping route comprising the first location and the second location; and
predicting a second shipping route for the second container based on the second container being associated with the second destination, the predicted second shipping route comprising the first location, the second location, and the third location,
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the predicted first and second shipping routes each comprising the first location and the second location.

12. The method of claim 8, wherein the container shipping information indicates a first shipping service type associated with the first container and a second shipping service type associated with the second container, and
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the first container being associated with the first shipping service type, and (vii) the second container being associated with the second shipping service type.

13. The method of claim 12, wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, (vi) the first container being associated with the first shipping type and the second container being associated with the second shipping type, and (vii) a determination of a relatedness between the first and second shipping service types.

14. The method of claim 8, further comprising:
obtaining scan event information regarding scan events, each of the scan events being for a container that has not yet been delivered to its final destination, the scan events comprise a first set of scan events occurring at the first location, a second set of scan events occurring at the second location, and a third set of scan events occurring at the third location,
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the scan event information comprising the first, second, and third sets of scan events.

15. The method of claim 14, wherein the container shipping information indicates, for each container for which at least one of the scan events has occurred at the first, second, or third locations, a shipping service type associated with the container, and
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, (vi) the scan event information comprising the first, second, and third sets of scan events, and (vii) the shipping services types associated with the containers for which the scan events has occurred.

16. The method of claim 8, further comprising:
obtaining historical scan event information regarding prior scan events, each of the scan events being for a container that has been delivered to its final destination, the prior scan events comprise a first set of prior scan events occurring at the first location, a second set of prior scan events occurring at the second location, and a third set of prior scan events occurring at the third location,
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the historical scan event information comprising the first, second, and third sets of prior scan events.

17. A system for facilitating model-based tracking-related prediction for shipped containers, the system comprising:
a computer system that comprises one or more processors programmed with computer program instructions that, when executed, cause the computer system to:
obtain container shipping information, the container shipping information indicating a first destination associated with a first container and a second destination associated with a second container;
obtain first-location event information, the first-location event information indicating a first-location scan event associated with the first container that occurred at a first location and a first-location scan event associated with the second container that occurred at the first location;
obtain second-location event information, the second-location event information indicating a second-location scan event associated with the first container that occurred at a second location different from the first location; and
use, without a second-location scan event for the second container occurring at the second location, a prediction model to generate a prediction regarding (i) the second container being at the second location subsequent to being at the first location and (ii) the second container being at a third location different from the first and second location subsequent to being at the second location,
wherein the prediction regarding the second container is generated, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

18. The system of claim 17, wherein the generated prediction is an approximation of a time at which the second container is located at the second location and a future time at which the second container will be located at the third location,
wherein the approximation is performed, using the prediction model, without a second-location scan event for the second container occurring at the second location, and
wherein the approximation is performed, using the prediction model, based on the (i) the first container being associated with the first destination, (ii) the second container being associated with the second destination, (iii) the first-location scan event being associated with the first container, (iv) the first-location scan event being associated with the second container, and (v) the second-location scan event being associated with the first container.

19. The system of claim 17, wherein the computer system is further caused to:
predict a first shipping route for the first container based on the first container being associated with the first destination, the predicted first shipping route comprising the first location and the second location; and
predict a second shipping route for the second container based on the second container being associated with the second destination, the predicted second shipping route comprising the first location, the second location, and the third location,
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the predicted first and second shipping routes each comprising the first location and the second location.

20. The system of claim 17, wherein the container shipping information indicates a first shipping service type associated with the first container and a second shipping service type associated with the second container, and
wherein the prediction regarding the second container is generated, using the prediction model, based on the (i) the first container being associated with the first destination, (ii) the second container being associated with the second destination, (iii) the first-location scan event associated with the first container, (iv) the first-location scan event associated with the second container, (v) the second-location scan event associated with the first container, and (vi) the first container being associated with the first shipping service type, and (vii) the second container being associated with the second shipping service type.
